(19) United States
(12) Patent Application Publication
(10) Pub. No.: US 2018/0073816 A1
(43) Pub. Date: Mar. 15, 2018

(54) HIGH-THERMAL CONDUCTIVITY ADSORBENTS FOR RAPID ABSORPTION OF HEAT PULSES AND A PRESSURE-CASCADE BURST DESORPTION SYSTEM USING THE SAME

(71) Applicant: Government of the United States as Represented by the Secretary of the Air Force, Wright-Patterson AFB, OH (US)

(72) Inventors: Patrick J. Shamberger, College Station, TX (US); Ajit Roy, Beavercreek, OH (US)

(73) Assignee: Government of the United States as Represented by the Secretary of the Air Force, Wright-Patterson AFB, OH (US)

(21) Appl. No.: 15/815,821

(22) Filed: Nov. 17, 2017

Related U.S. Application Data
(62) Division of application No. 14/068,005, filed on Oct. 31, 2013.
(60) Provisional application No. 61/720,416, filed on Oct. 31, 2012.

(51) Int. Cl. F28D 17/02; B01J 20/20; B01J 20/28; B01J 20/02; F28D 20/00

(52) U.S. Cl. CPC F28D 17/02; Y02E 60/142; B01J 20/205; B01J 20/28047; B01J 20/28066; B01J 20/20; B01J 20/02; F28D 20/003

(57) ABSTRACT

A composite adsorbent and heat burst desorption system and method using the same. The composite adsorbent material includes a backbone and a filler. The backbone comprises a first material having a high thermal conductivity and a plurality of pore. The filler, within the pores of the backbone, comprises a second material having a large specific surface area.

This application is a Divisional of co-pending U.S. application Ser. No. 14/068,005, filed Oct. 31, 2013, which claims the benefit of and priority to Provisional Application No. 61/720,416, filed Oct. 31, 2012. The disclosure of each of these applications is incorporated herein by reference, each in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to the rapid absorption of heat pulses and, more particularly, to adsorbents and systems for rapid absorption of heat pulses.

### BACKGROUND OF THE INVENTION

Technological advances in electronics, avionics, and automotive industries are often accompanied by a further need for energy storage. However, the energetic needs of these platforms often result in high thermal output. At times, the thermal output may include large bursts of heat (ranging from about 100 kW to about 1 MW) over a relatively short period of time (about 10 seconds to about 100 seconds). Conventional systems of managing the heat produced by these platforms have included micro- and meso-porous materials (e.g., activated carbons, zeolites, silica, and alumina gels) having large specific surface areas (ranging from about 1000 m²/g to about 2000 m²/g). However, some of these materials (zeolites and silica gels) have poor thermal conductivity due to low intrinsic thermal conductivity or poor consolidation of powders.

Certain gases and vapors (e.g., NH₃, CO₂, MeOH, and H₂O), known and used as adsorbates, adsorb onto solid adsorbents, such as the micro- and meso-porous materials with large heats of adsorption. Exemplary heats of desorption, on an adsorbate-mass basis, are shown below in Table 1. However, these systems (solid/vapor desorption systems) have conventionally been used as refrigerators or heat pumps that function on a continuous, low instantaneous, cooling power basis. Therefore, these conventional systems have not been suitable for use in adequately adsorbing rapid bursts of heat, particularly over the lifetime of the platform.

TABLE 1

| | | ΔH_{adsorption} in |
|---|---|---|
| Adsorbent | Adsorbate | [MJ/kg_{adsorbate}] |
| Silica gel | CH₃OH | 1.0-1.5 |
| | H₂O | 2.8 |
| Activated alumina | H₂O | 3.0 |
| Zeolites | H₂O | 3.3-4.2 |
| | NH₃ | 4.0-6.0 |
| | CO₂ | 0.8-1.0 |
| | CH₃OH | 2.3-2.6 |
| Activated carbon | C₂H₄ | 0.4-1.2 |
| | C₄H₁₀ | 0.3 |
| | CH₂F₂ | 0.4 |
| | NH₃ | 2.0-2.7 |
| | H₂O | 2.3-2.6 |
| | CH₃OH | 1.8-2.0 |
| | C₂H₅OH | 1.2-1.4 |

Other conventional approaches to thermal management have incorporated macroporous foams (e.g., graphitic, aluminum, and copper foams), having high effective thermal conductivities (ranging from about 20 W/m·K to about 200 W/m·K). Yet, macroporous foams are incapable of adsorbing large quantities of adsorbates due to low specific surface areas (ranging from about 10 m²/g to about 100 m²/g).

Thus, there remains a need for large high-thermal conductivity adsorbents, particularly for use in systems configured to manage large thermal loads and accommodate short periods of rapid cooling. Furthermore, and in particularly for uses with respect to deployed military platforms, new devices are needed that are light weight, compact, low cost, low maintenance, and safe to operate (with respect to toxicity, flammability, and reactivity).

### SUMMARY OF THE INVENTION

The present invention overcomes the foregoing problems and other shortcomings, drawbacks, and challenges of conventional heat adsorption materials and systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention, a composite adsorbent includes a backbone and a filler. The backbone comprises a first material having a high thermal conductivity and a plurality of pore. The filler, within the pores of the backbone, comprises a second material having a large specific surface area.

Another embodiment of the present invention is directed to a heat burst desorption system for absorbing rapid heat bursts from a heat load. The system includes an adsorbent bed containing an adsorbent and an adsorbate supply containing an adsorbate. The adsorbate is configured to adsorb onto the surface of the adsorbent with a large heat of adsorption. The system operates in an absorption mode and a recharge mode. In the absorption mode, when heat is transferred from the heat load to the adsorbent bed, the adsorbent bed is fluidically coupled to an exhaust such that adsorbate desorbs from surface of the adsorbent and is vented. In the recharge mode, heat is rejected from the system along a second transfer path, the adsorbent bed is fluidically coupled to the adsorbate supply such that adsorbate adsorbs onto the surface of the adsorbent.

According to still another embodiment of the present invention, a method of absorbing rapid heat bursts from a heat load includes decompressing an adsorbent bed, containing an adsorbent, when heat is generated. When heat generation cases, the adsorbent bed is recharged with an adsorbate, which is configured to adsorb onto a surface of the adsorbent.

Yet another embodiment of the present invention is directed to a composite adsorbent having a thermally-conductive backbone and a filler. The backbone includes a first material having plurality of pore therein and the filler is within those pores. A second material, comprising the filler, has a large specific surface area.

In accordance with another embodiment of the present invention, an adsorbent includes a plurality of thermally-conductive elements. Elements of the plurality interface with other elements of the plurality to form a three-dimensional network. The elements may include carbon nanotubes, multi-wall carbon nanotubes, metallic nanowires, semiconducting nanowires, graphene, or a combination thereof.

An embodiment of the present invention includes a composite adsorbent having a backbone and a filler. A first material, which comprises the backbone, includes a plurality of pores therein and a thermal conductivity greater than about 20 W/m·K. A second material, which comprises the filler, has a specific surface area greater than about 1000 m²/g.

The above and other objects and advantages of the present invention shall be made apparent from the accompanying drawings and the descriptions thereof.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 is a flowchart illustrating methods of forming a composite adsorbent in accordance with two embodiments of the present invention.

FIG. 2 is a schematic representation of one method shown in FIG. 1.

FIG. 3 is a schematic representation of one method shown in FIG. 1.

FIG. 4 is a schematic representation of a three-dimensional composite adsorbent in accordance with another embodiment of the present invention.

FIG. 5 is a diagrammatic view of a burst desorption system in accordance with one embodiment of the present invention.

FIGS. 5A and 5B illustrate operation of the burst desorption system during an absorption mode and a recharging mode, respectively.

### DETAILED DESCRIPTION OF THE INVENTION

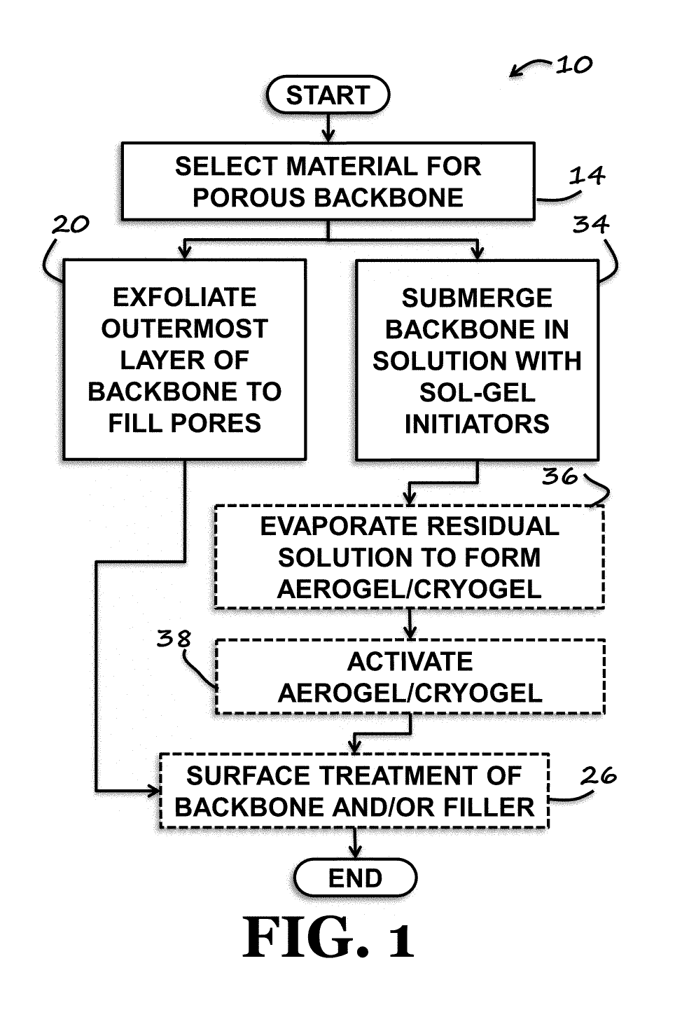

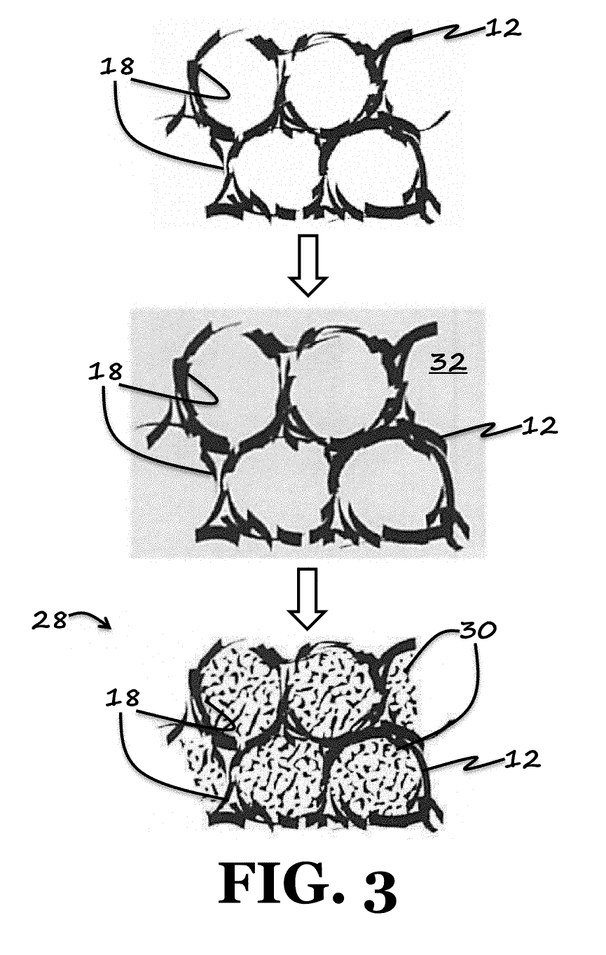

Turning now to the figures, and in particular to FIGS. 1-3, methods for building composite, high-thermal conductivity adsorbents in accordance with embodiments of the present invention are described. A first method, as shown in the flowchart 10 of FIG. 1, begins with selection of a material comprising a porous backbone 12 (Block 14) for a desired composite adsorbent 16. The material is generally porous (illustrated as pores 18) and may be selected, at least in part, on (1) the thermal conductivity characteristics of the material and (2) the desired degree of heat pulse absorption. Graphitic foams, such as commercially-available POCOFoam and Koppers KFOAM, described in detail in U.S. Pat. No. 6,033,506, the disclosure of which is incorporated herein by reference in its entirety, have a thermal conductivity, low bulk density, and a connected open network of pores with tunable diameters.

In Block 20 of the flowchart 10, an outermost layer of the material comprising the backbone 12 is exfoliated and fills pores 18 of the backbone 12. One method of exfoliation, according to one exemplary embodiment, places the porous backbone 12 into an acidic bath such that ionic solvent may intercalate into the pores 18. The intercalating species (illustrated as intercalating solvent 22) may include, for example, SO₄, NO₃, or other like ionic groups. With the intercalating solvent 22 permeated throughout the backbone 12, the backbone 12 may then be rapidly heated such that outermost layers exfoliate from the backbone 12 and reside within the pores 18 as exfoliate filler 24.

If desired, the backbone 12 and/or the exfoliate filler 24 may be surface treated so as to further tune adsorbate-adsorbent interaction within the composite adsorbent 16 (Block 26). For instance, polar ionic species (e.g., acidic functional groups, nitrates, and sulfates) may be added to change the polarity of the adsorbent surface of the backbone 12. Additionally, or alternatively, liquid, vapor, or plasma treatments may be used to further modify the adsorbent surface of the backbone 12 or of the filler 24.

A second method of forming a composite adsorbent 28, also shown in the flowchart of FIG. 1, begins with selection of a first material comprising the porous backbone 12. Again, the backbone 12 is generally porous (illustrated as pores 18) (Block 14). According to the instant embodiment, the pores 18 are filled with a second material differing from the material comprising the backbone 12. One such method of incorporating the second material, i.e., a filler 30, into the pores 18 includes submerging the backbone 12 into a solution 32 containing one or more sol-gel initiators, for example, an aqueous resorcinol-formaldehyde solution (Block 34).

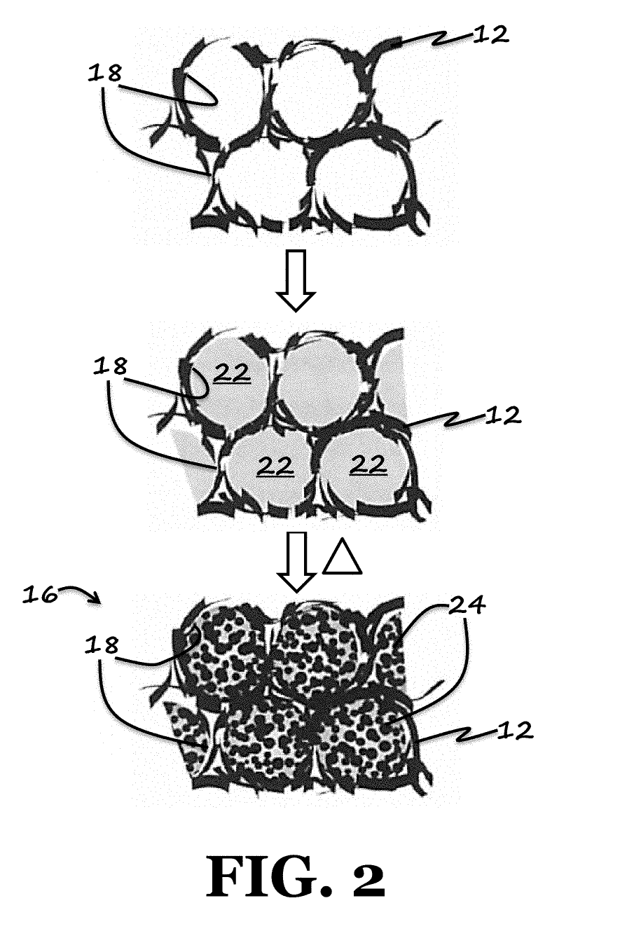

As residual solution is evaporated from the backbone 12, whether by supercritical or freeze drying, an aerogel or cryogel 30 forms, respectively, within the pores 18 (Block 36). If necessary, or desired, a reactive gas species may be directed through the filler 30 to develop a desired distribution of porosity (Block 38). And, as described previously with respect to the composite adsorbent 16 of FIG. 2, the composite adsorbent 28 and/or aerogel/cryogel filler 30 may be surface treated (Block 26), if desired or necessary.

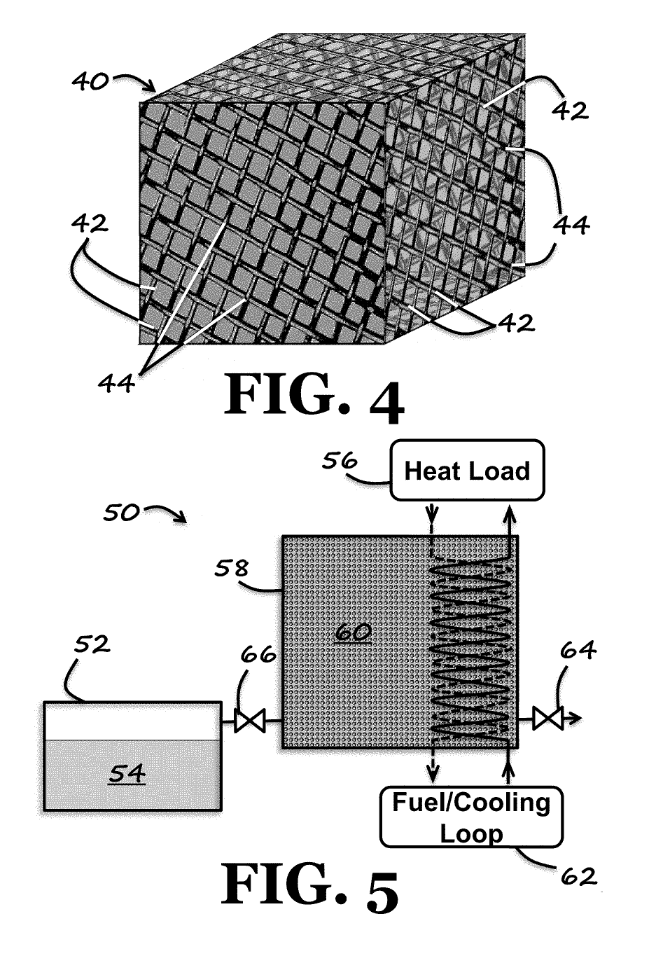

In some instances, high thermal conductivity may be required to extend in three dimensions. A three-dimensional adsorbent 40 suitable for such uses and according to one embodiment of the present invention is shown and described with respect to FIG. 4. The illustrative three-dimensional adsorbent 40 comprises a three-dimensional network of connected, high-thermal conductivity of elements 42 configured to form a dense mesh (on the order of 10⁸ interfaces/m to 10⁹ interfaces/m).

Each element 42 may be a carbon nanotubes (CNTs), a multi-wall CNT, a metallic or semiconducting nanowire, graphene, or other 2D structured material. The three-dimensional adsorbent forms a three-dimensional network to transmit heat over a large volume while providing a porous-like structure between adjacent ones of the elements 42. The illustrative structure permits significant adsorption of adsorbate species without restricting the flow of adsorbate molecules, the necessity of which is described in greater detail below.

One approach of synthesizing embodiments of the three-dimensional adsorbents 40 may include template-assisted growth from graphene. In this approach, two-dimensional graphene is grown on all outer surfaces of a connected network of metal, e.g., Ni, after which the metal is dissolved to leave the residual, covalently bonded CNT network.

While the three-dimensional adsorbent 40 may have large inherent thermal conductivity, the high interfacial density may suggest to those of ordinary skill in the art that the effective conductivity of the three-dimensional adsorbent 40 will be dominated by thermal interfacial resistance at nodes 44 formed at the intersection of connected individual elements 42. Small interfacial thermal resistance is likely to require strong bonding forces at the nodes 44 (e.g., covalent, ionic, or metallic bonds), which minimize the scattering of photons at those interfaces. Mechanisms to promote these nodes 44 may include introduction of metallic nanoparticles (which act as hubs connecting multiple tubes/wires), covalent bonding between individual elements (e.g., branching, covalently bonded CNT structures), or other similar mechanisms. Large specific surface areas of the three-dimensional adsorbent 40 may be derived from the large intrinsic specific surface areas of individual elements 42. Given that very little area is consumed by the nodes 44, the three-dimensional adsorbent 40 will, for the large part, maintain the specific surface area of the individual elements 42, which maximizes the area for gas or vapor molecules to adsorb to the adsorbent.

Composite materials, as described in the various embodiments of the present invention herein, are light-weight and have a high-thermally conductive. Generally, the high-dielectric porous backbone provides the desired high thermal conductivity while filler materials provide a large surface area, which promotes adsorbate interaction. By minimizing the thermal interfacial resistance between the backbone and the filler, heat transfer through the composite material is highly efficient.

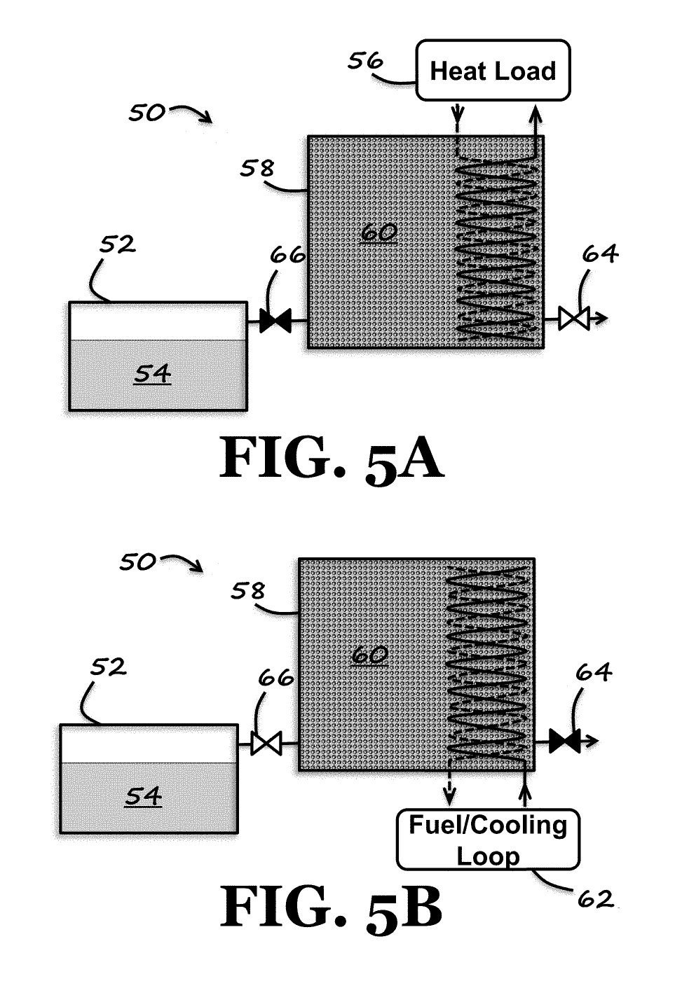

The composite materials, according to the various embodiments of the present invention, may be utilized in improving systems configured to quickly absorb bursts of heat. That is, these composite materials, when used with suitable gas or vapor adsorbates, rapidly absorb large pulses of heat. In that regard, and with reference now to FIG. 5, a burst desorption system 50 is shown and described in accordance with one embodiment of the present invention. The burst desorption system 50 includes a supply, illustrated as a tank 52, containing pressurized adsorbate 54, which may be selected, for example, from the listing provided in Table 1 above. The total volume of the tank 52 may be selected so as to compensate for the dissipation of heat required by the particular heat load 56 over the lifetime of the heat load 56 while a maximum pressure within the tank 52 is limited by safety considerations.

The fraction of the adsorbate to be used during system operation is determined by minimum and operating pressures. Exemplary pressures for the adsorbate tank 52 may range from about 50 bar to 100 bar; however, these pressure ranges are not considered to be limiting. Ideally, the adsorbate may be stored in the liquid phase to minimize the overall volume of the system.

The adsorbate tank 52 is fluidically coupled to an adsorbent bed 58 containing a composite adsorbent 60 according to embodiments of the present invention. The adsorbent bed 58 is operable over a range of pressures, for example, pressures ranging from about 10 bar to 50 bar, or, as necessary, to atmospheric pressure; however, these pressure ranges are not considered to be limiting. In any event, the adsorbent bed 58 may generally be under a lower pressure after discharge and a higher pressure after recharged, as provided in detail below. In some embodiments, the adsorbent bed 58 may not be pressured over the condensation pressure of the adsorbent 60 as depressurization may lead to rapid expansion within the adsorbent bed 58, which is likely to irreversibly damage the adsorbent 60. Furthermore, the maximum pressure of the adsorbent bed 58 may be intrinsically linked to the minimum pressure of the storage tank 52, as the storage tank 52 is maintained at a higher pressure than the adsorbent bed 58 in order to effectively recharge the adsorbent 60.

In use, the system 50 is operable in an absorption mode, during which heat is absorbed from the heat load 56, and in a recharge mode, during which the system 50 prepares for subsequent heat absorption by transferring absorbed heat to a cooling loop 62 of, for example, a fuel tank (not shown). More specifically, and in the absorption mode illustrated in FIG. 5A, heat is transferred from the heat load 56 to the adsorbent 60 of the adsorbent bed 58. Resultantly, the adsorbent bed 58 decompresses, causing some quantity of adsorbate 54 to desorb from the surface of the adsorbent 60, which dissipates a certain quantity of heat. The quantity of heat is related to the product of the quantity of adsorbate 54 desorbed and the specific heat of desorption. Further dissipation of heat may occur by the expansion of adsorbate while being exhausted via valve 64. The ordinarily-skilled artisan would readily appreciate that without such an open system, heat may be generated when the adsorbate 54 is recondensed or adsorbed.

Between heat burst generations, the system 50 is operated in a recharging mode to prepare for a subsequently generated heat burst. In that regard, the exhaust valve 64 is closed so that the adsorbent bed 58 may be re-pressurized from the adsorbate tank 52 via valve 66. Because adsorption is essentially the inverse process to desorption, some quantity of heat may be generated at the adsorbent bed 58, which must be rejected for the adsorption process to continue. However, generated heat is offset by the quantity of heat consumed by evaporating and/or decompressing adsorbate 54 from the tank 52. If the net effect is heat generation, the heat may be dissipated by some other element on the platform, including, for example, the cooling loop 62 of a fuel tank (not shown) or to the ambient environment by way of an air-heat exchanger. However, the rate of available heat rejection may limit the duty cycle of the system 50.

The skilled artisan will, with the benefit of the disclosure provided herein, note the particular benefit of a pressure cascade to store adsorbate gas/vapor, to control adsorption/desorption, and to regulate venting of the adsorbate 54.

The heat burst desorption system described according to the embodiments of the present invention herein may be configured to manage large thermal loads (about 100 kW to about 1 MW) with a rapid response time (less than about 1 second). Recharging capabilities are possible with a duty cycle of about 5% to about 50%, and, generally, the systems may be operational for extended periods of time, for example, missions ranging from 100 sec to 10,000 sec.

While the present invention has been illustrated by a description of various embodiments, and while these embodiments have been described in some detail, they are not intended to restrict or in any way limit the scope of the appended claims to such detail. Additional advantages and modifications will readily appear to those skilled in the art. The various features of the invention may be used alone or in any combination depending on the needs and preferences of the user. This has been a description of the present invention, along with methods of practicing the present invention as currently known. However, the invention itself should only be defined by the appended claims.

What is claimed is:

1. A method of absorbing rapid heat bursts from a heat load, the method comprising:
decompressing an adsorbent bed comprising an adsorbent when heat is generated by the heat load; and
recharging the adsorbent bed with an adsorbate when heat generation ceases, the adsorbate configured to adsorb onto a surface of the adsorbent.

2. The method of claim 1, wherein the adsorbent is the composite adsorbent comprises:
a first material comprising a backbone and having a plurality of pore therein; and
a second material intercalating the first material, filling the plurality of pores thereof, and having a specific surface area greater than about 1000 m²/g,
wherein a thermal conductivity of the first material is greater than a thermal conductivity of the second material.

3. The method of claim 2, wherein the thermal conductivity of the first material comprising the backbone is greater than about 20 W/m·K.

4. The method of claim 2, wherein the first material comprising the backbone is a graphitic foam, an aluminum foam, a copper foam, a three-dimensional network of carbon nanotubes, a three-dimensional network of multi-walled carbon nanotubes, a three-dimensional network of metallic or semiconducting nanowires, grapheme, or a combination thereof.

5. The method of claim 2, wherein the second material is an aerogel or a cryogel.

6. The method of claim 2, wherein a surface of the first material comprising the backbone, a surface of the second material comprising the filler, or both is chemically modified.

7. The method of claim 6, wherein the chemical modification includes introduction of a polar ionic species.

8. The method of claim 2, wherein the second material is an exfoliated outer layer of the first material.

9. The method of claim 1, wherein heat generated while recharging the adsorbent bed is rejected from the adsorbent bed.

10. The method of claim 1, wherein the rejected heat is transferred to a cooling loop.
